(19) United States
(12) Patent Application Publication
(10) Pub. No.: US 2003/0089532 A1
(43) Pub. Date: May 15, 2003

(54) Body fat monitoring device

(75) Inventor: Brian Stephens, Dun Laoghaire (IE)

Correspondence Address: William R. McClellan, Wolf, Greenfield & Sacks, P.C., 600 Atlantic Avenue, Boston, MA, 02210, US

(73) Assignee: Terraillon Holdings Limited, Dublin (IE)

(21) Appl. No.: 10/177,256

(22) Filed: Jun. 21, 2002

(30) Foreign Application Priority Data
Jun. 22, 2001 (GB) 0115353.5

(51) Int. Cl. G01G 19/22; G01G 19/34; G01G 19/00; G01G 23/00

(52) U.S. Cl. 177/245

(57) ABSTRACT

The invention relates to a body fat monitoring device comprising a transparent glass platform which has metal electrical contacts exposed for contact with skin of the toe and heel region of the foot of a user. Activation of the contacts in turn activate electronics which convert the reading into water content of the body of the user, which data is in turn converted into body fat data, being commensurate therewith and calculable therefrom, and which body fat data is displayed on an LCD.

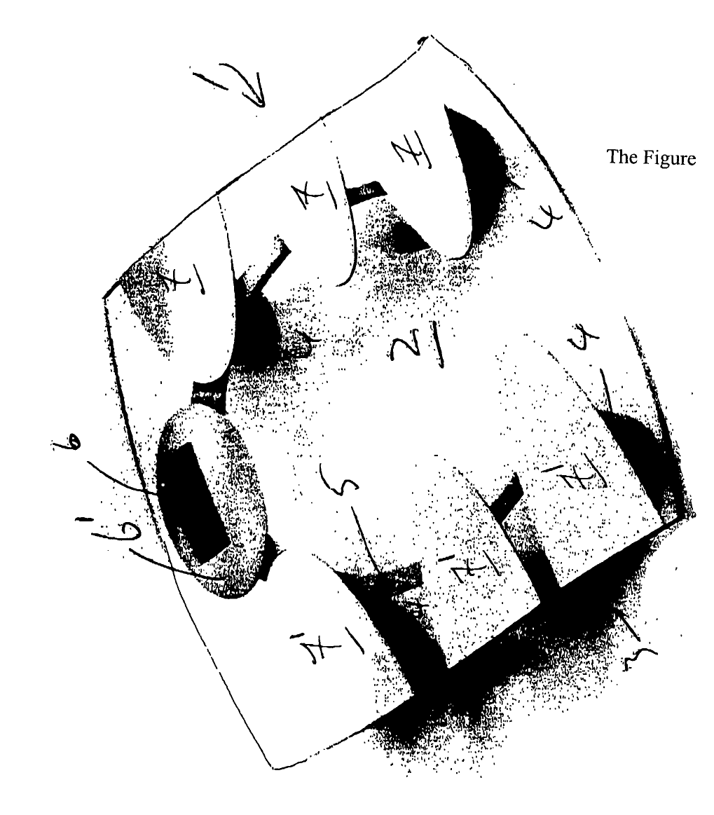

### RELATED APPLICATIONS

This application claims priority under 35 U.S.C. §119(a) to U.K. Patent Application No. 0115353.5, entitled A BODY FAT MONITORING DEVICE, filed Jun. 22, 2001, which is incorporated by reference.

### BACKGROUND OF THE INVENTION

The invention relates to a personal body fat monitoring device, and particularly to such a device incorporating a personal weighing scale.

### SUMMARY OF THE INVENTION

According to the invention there is provided a personal body fat monitoring device, characterised by at least one major surface element, electrical contacts exposed for contact by feet of a user, and electronic means for calculating body fat actuated by the contacts, the arrangement being such that when the electrical contacts are contacted, the body fat of a user is determined.

The major surface of the element may comprise a weight receiving platform of the scale. This provides a relatively simple construction.

The platform may comprise glass an upper in use major planar surface of which holds the contacts. This provides a relatively simple yet effective construction, particularly when the glass may comprise a sheet of glass per se.

Thus the major planar surface may be an upper, in use, surface of the platform.

The contacts may be disposed so as to provide a desired array whereby to be exposed and thus contactable by toe and heel regions of the feet of a user in use.

The glass may be a glass material. Herein the expression “glass material” includes glass or a glass-like material. In a preferred embodiment the weight-receiving element comprises glass per se, suitably transparent glass.

The device may extend to be also a personal weighing scale. This provides a composite obesity and weight monitoring device.

The contacts may be mechanically secured to a major surface of the platform, may be secured by an adhesive to a major surface of the platform, may be secured by electro-deposition or similar film contact to a major surface of the platform, or may be etched into a major surface of the platform. All these options provide a relative simple yet positive electrical contact with the user, whereby the body fat of a user may be monitored.

### BRIEF DESCRIPTION OF DRAWINGS

The FIGURE illustrates an example of a personal body fat monitoring device.

### DETAILED DESCRIPTION OF THE INVENTION

A personal weighing scale in the form of a body fat monitor is hereinafter described, by way of example, with reference to the accompanying drawing, which shows a perspective view of the scale from above.

Referring to the drawings there is shown a personal body fat monitoring device 1, comprising at least one major surface element 2 which comprises a glass material. In the embodiment the major surface element 2 is a weight receiving platform of the scale 1 which platform is made of transparent glass.

The platform 2 is supported on a base 3 comprising a load bearing mechanism in the embodiment having four feet 4 and an omega-shaped support 5. There is an LCD or LED read-out 6 and electronic means 6′ comprising circuitry (not shown) and an array of electrical contacts 7 whereby when a user steps on the platform 2, placing his or her feet on the array of contacts to right and left 7 and 7′ respectively (as viewed), the electronic means, which is programmed to provide a read-out of body fat of the person, is activated via the contacts 7, 7′ to provide that body fat read-out at the LCD or LED 6.

The contacts 7, 7′ are carried by the upper (in use) major surface of the weight receiving platform 2 being secured thereto or therein or thereon by an suitable means such as mechanically, by adhesive, by electro-deposition or etching.

It will be understood too that modifications are possible, for example the array of contacts 7, 7′ can be in any desired configuration other than the one shown, and the support may be a glass material body or base rather than the feet 4 and omega-shaped support 5 shown. Thus the body fat monitor may be a block of glass in, on or adjacent an upper surface in use on which a user stands and which carries the contacts 7, 7′.

The configuration of the contacts 7, 7′ may be according to design and kw-impedance or capacitance requirements in providing body fat monitoring.

The glass platform is sufficiently strong to support the weight of a user.

Glass or a glass-like material as described and shown with reference to the drawing is preferred for the platform 2 at least as it can be readily formed to a desired shape and configuration as by cutting, so that no expensive moulding tool is required as is the case when plastic is used. This results in a lower production cost, and moreover glass is relatively easy to clean, easier than plastic, and is easy to maintain. Glass or glass material also provides a positive electrical connection of the contacts and electronic circuitry so as to provide a consistent monitoring of body fat of the user, and hence consistent read outs when the device is used regularly or sporadically over a period of time.

It will be understood in particular, that the contacts 7, 7′ are of metal and exposed in the upper major surface of the glass platform 2, and are so disposed in a desired array that the toe region and heel region of each foot of a user makes firm skin contact with the contacts in use. The contacts activate the electronic means which records from the weight of the person, the water content of the legs of that person and converts that data to a body fat reading, which is displayed on the LCD or LED 6, body fat being directly calculable from the said water content.

A device as shown in the drawing can also be used as a personal weighing scale, the electronics 6′ being in addition to monitoring and calculating body fat, also being able to calculate, and display at the LCD 6, the weight of a user.

What is claimed is:

1. A personal body fat monitoring device, comprising:
(i) at least one major surface element;
(ii) electrical contacts exposed for contact by feet of a user; and
(iii) electronic means for calculating body fat actuated by the contacts, whereby when the electrical contacts are contacted, the body fat of a user is determined.

2. A device as defined in claim 1, wherein the major surface element comprises a weight receiving platform of the device.

3. A device as defined in claim 1, wherein the platform comprises glass an upper in use major planar surface of which holds the contacts.

4. A device as defined in claim 2, wherein the glass comprises a sheet of glass per se.

5. A device as defined in claim 3, wherein the contacts are mechanically secured to the major surface of the glass platform.

6. A device as defined in claim 3, wherein the contacts are secured by an adhesive to the major surface of the glass platform.

7. A device as defined in claim 3, wherein the contacts are secured by electro-deposition to the major surface of the glass platform.

8. A device as defined in claim 3, wherein the contacts are secured by film contact to the major surface of the glass platform.

9. A device as defined in claim 3, wherein the contacts are etched with the major surface of the glass platform.

10. A device as defined in claim 3, wherein the major planar surface is an upper, in use, surface of the platform.

11. A device as defined in claim 3, wherein the contacts are disposed so as to provide a desired array whereby to be contactable by toe and heel regions of the feet of a user in use.

12. A personal body fat monitoring device as defined in claim 1, characterised by also being a personal weighing scale.
